(19) United States
(12) Patent Application Publication
(10) Pub. No.: US 2025/0095438 A1
(43) Pub. Date: Mar. 20, 2025

(54) SYSTEMS AND METHODS OF COMPLETELY ON DEMAND AI-GENERATED GAMES VIA PLAYER'S NATURAL LANGUAGE PROCESSING

(71) Applicant: IGT, Las Vegas, NV (US)

(72) Inventors: Michael Russ, Graz (AT); Soheil Latifi, Brampton (CA)

(21) Appl. No.: 18/368,825

(22) Filed: Sep. 15, 2023

(51) Int. Cl. G07F 17/32; G06F 40/40

(52) U.S. Cl. CPC G07F 17/3227; G06F 40/40; G07F 17/323

(57) ABSTRACT

Embodiments of the present disclosure use generative Artificial Intelligence (AI) and Natural Language Processing (NLP) to adjust and/or create an electronic game of chance. For example, a slot player can ask a generative AI, in plain language, to generate a slot game of their design. Embodiments can generate the entire game on-the-fly, in real-time based on the player's request. Additionally, or alternatively, the game can be modified by player, on demand, by giving additional and/or adjusting input.

### BACKGROUND

The present disclosure is generally directed to customization of games of chance and more particularly to using natural language processing and generative artificial intelligence to generate and/or customize a game of chance on demand and on-the-fly.

In a casino environment, games which appeal to a player and create a sense of excitement can increase player engagement. Increased player engagement in turns leads to increased use of the game and revenues for the operator of the casino. Thus, rather than providing a static, pre-defined game, there is a need to provide new games on a regular basis. Additionally, providing a manner in which individual players can easily, quickly, and on-demand design, generate, and/or customize unique, personalized games will further increase interest and excitement among players.

### BRIEF SUMMARY

Embodiments of the present disclosure are directed to systems and methods for on-demand generation and/or customization of electronic games of chance using natural language processing and generative artificial intelligence. According to one embodiment, a system can comprise a processor and a memory coupled with and readable by the memory. The memory can store therein a set of instruction which, when executed by the processor, causes the processor to receive, from a gaming system, an audio stream comprising a natural language description of an electronic game of chance, perform natural language processing on the received audio stream, extract, from the received audio stream, a set of parameters for the electronic game of chance based on the natural language processing of the received audio stream, and generate a set of configuration information defining the electronic game of chance based on the extracted set of parameters for the electronic game of chance.

Generating the set of configuration information defining the electronic game of chance can be further based on a set of restrictions placed on the electronic game of chance. For example, the set of restrictions comprise a set of regulatory restrictions. In such cases, the instructions can further cause the processor to determine a geographic location of the gaming system and the set of regulatory restrictions can be selected based on the determined geographic location of the gaming system. Additionally, or alternatively, the set of restrictions comprise restrictions based on a game type for the electronic game of chance indicated by the extracted set of parameters for the electronic game of chance. For example, the restrictions based on the game type for the electronic game of chance comprise restrictions on a random number generator used by the electronic game of chance. In yet other cases, the set of restrictions can additionally, or alternatively, comprise restrictions defined by an operator of the gaming system and/or restrictions defined by a manufacturer of the gaming system. In any such cases, the instructions can then cause the processor to provide, to the gaming system, the generated set of configuration information defining the electronic game of chance.

According to another embodiment, a method for configuring an electronic game of chance can comprise receiving from a gaming system, an audio stream comprising a natural language description of an electronic game of chance, performing natural language processing on the received audio stream, extracting a set of parameters for the electronic game of chance from the received audio stream based on the natural language processing of the received audio stream, generating a set of configuration information defining the electronic game of chance based on the extracted set of parameters for the electronic game of chance, and providing, to the gaming system, the generated set of configuration information defining the electronic game of chance.

In some cases, configuring the electronic game of chance can be performed in real-time upon initiation of the electronic game of chance. Additionally, or alternatively, configuring the electronic game of chance can comprise changing the electronic game of chance after conducting the electronic game of chance for a period of time. The extracted set of parameters for the electronic game of chance and the set of configuration information defining the electronic game of chance can, in some cases, further define a sub-game conducted within the electronic game of chance.

In some cases, an electronic message comprising a request for confirmation of the extracted set of parameters for the electronic game of chance can be sent to the gaming system. Additionally, or alternatively, an electronic message comprising a request for additional description of the electronic game of chance can be sent to the gaming system. In some cases, an electronic message comprising an explanation of the electronic game of chance can additionally, or alternatively, be sent to a player.

According to yet another embodiment, a non-transitory, computer-readable medium comprising a set of instructions stored therein which, when executed by a processor, can cause the processor to: receive, from a gaming system, an audio stream comprising a natural language description of an electronic game of chance, perform natural language processing on the received audio stream, extract, from the received audio stream, a set of parameters for the electronic game of chance based on the natural language processing of the received audio stream, generate a set of configuration information defining the electronic game of chance based on the extracted set of parameters for the electronic game of chance, and provide, to the gaming system, the generated set of configuration information defining the electronic game of chance. The generated set of configuration information can relate to any one or more of game play characteristics of the electronic game of chance, a theme for the electronic game of chance, audio characteristics of the electronic game of chance, mathematic characteristics of the electronic game of chance, and/or other characteristics or aspects of the electronic game of chance.

Additional features and advantages are described herein and will be apparent from the following Description and the figures.

### BRIEF DESCRIPTION OF THE SEVERAL VIEWS OF THE DRAWINGS

FIG. 1 is a block diagram illustrating elements of an exemplary environment in which electronic game of chance configuration can be performed according to embodiments of the present disclosure.

FIG. 2 is a block diagram illustrating additional details of components of an exemplary host system for configuring an electronic game of chance according to one embodiment of the present disclosure.

FIG. 3 is a flowchart illustrating an exemplary process for performing electronic game of chance configuration according to one embodiment of the present disclosure.

FIG. 4 is a flowchart illustrating an exemplary process for performing electronic game of chance configuration according to another embodiment of the present disclosure.

FIG. 5 is a flowchart illustrating an exemplary process for performing electronic game of chance configuration according to yet another embodiment of the present disclosure.

FIG. 6 is a flowchart illustrating an exemplary process for performing electronic game of chance configuration according to still another embodiment of the present disclosure.

### DETAILED DESCRIPTION

Embodiments of the present disclosure use generative Artificial Intelligence (AI) and Natural Language Processing (NLP) to adjust and/or create an electronic game of chance. For example, a slot player can ask a generative AI, in plain language, to generate a slot game of their design. Embodiments can generate the entire game on-the-fly, in real-time based on the player's request. Additionally, or alternatively, the game can be modified by player, on demand, by giving additional and/or adjusting input.

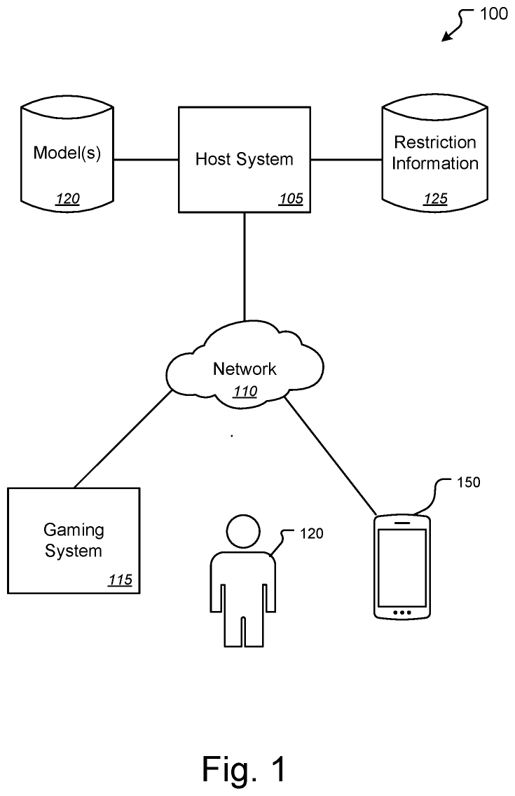

FIG. 1 is a block diagram illustrating elements of an exemplary environment in which electronic game of chance configuration can be performed according to embodiments of the present disclosure. As illustrated in this example, the environment 100 can comprise a host system 105 coupled with a communications network 110. The host system 105 can comprise any one or more servers and/or other computing devices as known in the art. The communications network 110 can comprise any one or more wired and/or wireless local-area and/or wide-area networks as known in the art including, but not limited to, the Internet. The environment 100, such as may be found in a casino or other gaming venue, can include one or more gaming systems 115 such as an Electronic Gaming Machine (EGM) or similar system accessible by a player 120. The gaming system 115 can execute any of a wide variety of electronic games including, but not limited to, slots, video poker, video keno, and/or any other such game of chance.

Generally speaking, embodiments of the present disclosure use AI and NLP to adjust and/or create an electronic game of chance to be executed by the gaming system 115. For example, a slot player can ask a generative AI executed by the host system 105 to generate a slot game of their design. This can be based on verbal communication from the player 120 received through a microphone (not shown here) in the gaming system 115 or through the player's mobile device 125. For example, the player 120 may say: “I want to play a 4×5 reel slot game, Avatar 2-themed, where Jake Sully and Ney'tiri are the two top symbols, it shall be under-water themed, highly volatile, bet levels shall range from 50 credits to 1,000 credits and hitting the jackpot shall award me with 10,000 dollars. The music shall progress as I play, replaying soundtracks in the order of how they appear in the movie”. The host system 105 can then generate the entire game on-the-fly, in real-time based on the player's request. The generated game configuration can then be downloaded from the host system 105 to the gaming system 115 via the communications network 110 to be to be executed by the gaming system 115. Additionally, or alternatively, the game can be modified by player, on demand, by giving additional and/or adjusting input.

More specifically, an audio stream comprising verbal instructions or description of a game from the player 120 can be received by the host system 105. The instructions or description from the player can describe a new game or modifications to a proposed or existing game. For example, the audio stream can comprise feedback from the player based on previous AI outputs from the host system 105. Sample game elements that can be created or modified based on the player's description can include, but are not limited to, game characteristics such as reel matrix, game rules, base game features, bonus game features, etc., theme characteristics such as a game theme, background, light & atmosphere, symbol ornaments, etc., audio characteristics such as background music, symbol sounds, game feature sounds, etc., math characteristics: such as RTP, volatility, bet levels, side bet features, jackpot types, jackpot sum, jackpot frequency, etc., and/or others.

In some cases, background noise, e.g., from the casino in which the gaming system 115 is located, may also be captured in the audio stream. One way to deal with this noise can be to tune the gaming system's 115 microphone's sensitivity level based on its distance to the player 120. In this way thus, the microphone can detect noises that come from such as distance but not from further away. In other cases, a directional microphone that just detect noise from a given direction, i.e., where the player 120 is about to be in front of the gaming system 115 can be used. In another approach, the host system 105 can be trained to recognize the voice of certain players and only commands from recognized voices. In yet another approach, the host system 105 or gaming system 115 can connect to the player's mobile device 120 to use this as input since these microphones are well built to only recognize sound from a close distance. In other cases, a microphone could be integrated into a chair of the gaming system 115, e.g., in the headrest so that it is close to the player's mouth. In yet another example, the host system and/or gaming system 115 could train a noise cancellation model based on usual noises being heard in the casino. When such noises happen, they could be ignored and thus, misunderstandings decreased.

Once the audio stream is received, natural language processing can be applied by the host system 105 to generate game configuration information based on parameters extracted by the natural language processing, one or more models 130 for various games, and a set of restriction information 135. Restrictions based on a generated game can be based on governmental regulations relevant to where the gaming system 115 is located. For example, the host system 105 can know in which casino, and in which state the gaming system 115 is located, consider allowed RTP-ranges and other regulatory restrictions, and keep everything within the regulations. This can be incorporated into the gaming system 115, e.g., with metadata that specifies where the gaming system 115 is located. Also, internet connection could be considered to have the gaming system 115 or host system 105 retrieve latest information about regulations in real-time. Regional restrictions can also be represented in the model 130. That is, the model 130 can represent the correlation of the already designed games with the restrictions which can be applied to the restrictions to the generated output.

Restriction information 135 can also be based on the nature and/or characteristics of games of chance and/or the random number generator used. The random number generator restrictions can also be represented through the model 130 in the training pipeline. The model 130 as mentioned before understands how certain commands such as “no free spins on low wagers” mean that the game should have a toggle system to turn off the bonus games if the player puts low wagers. Furthermore, the player would not be allowed to create a game that is complete wishful thinking. Of course, the model 130 would respect that the game remains a game of chance, at least, whenever it comes to payout-relevant events.

In some cases, if it is the player's preference, a non-payout-relevant minigame could be part of the game of chance. Such as, in case the player would wish more variety, after winning big or after a certain trigger, providing the player with a fun mini-game, which would, however, not be in context with any winnings or skill-like wager gaming. The basics of the game would remain with a “game of chance”-like character, that can be well balanced to meet these games types' characteristics. Thus, the model 130 can be capable of calculating math/paytable simulations to retain the RTP and other game designer relevant gaming aspects.

Therefore, in one embodiment, the model can have, in real-time, connection to other games and their game mechanics, features, math paytables, etc. to get inspired thereby and to know which feature shall be triggered how often which can be balanced between math & the desire of the player, e.g., how often they would like to have it triggered. For example, if the player wishes the game to contain a bonus trigger that is triggered at least every 100 games, then the model would be used to calculate the maximum win of the bonus, etc., to remain in the RTP range, even though it will be triggered every 100 games.

Restriction information 135 can also represent restrictions applied by the operator and/or manufacturer of the gaming system 115. That is, along with the regional regulation and restrictions, manufacturers can apply their own restrictions to the training pipeline, the training process is the same, the model understands how each regulation affects the resulting game and applies them to the generated games. For example, the model can learn that if the frequency of free spins is 5% then the bonus games only proc 5 percent of the times, this learning process is achieved when the model understands that previously generated games interpret the frequency of 5 percent as the rate of bonus games. In one embodiment, the casino operator can allow or restrict several categories of game parameters for the model. For example, an operator might not want to allow a game to have a jackpot greater than X $. In another example, based on local hot topics, the operator might not want to allow several game themes, e.g., a Russian game themes during the Russia-Ukraine war.

As noted, the host system 105 can provide game configuration and/or adjustments to the gaming system 115. In some cases, the host system 105 can provide questions through the gaming system 115 or mobile device 125 of the player 120, e.g., check if something was understood correctly, asking the player to elaborate more on details, etc. Additionally, or alternatively, the host system 105 can give hints to the player 120 about game changes, explaining what they can change, providing tutorial-like explanations about how to define changes, about the generated game, etc.

In some cases, the generated game can be saved for further use. For example, progressive game play can be saved for the player and restored with all progress made in the game by their next visit. In some cases, the game can be uploaded to an online community database which can be browsed by other players. Others in the community could then download, play, rate and/or adjust games from the community database.

According to one embodiment, the host system 105 can analyze the player's behavior over time and learn from their preferences. The host system 105 can remember which game parameters (game elements, reel slot matrixes, themes, volatilities, . . . ) the player requested repeatedly and consider that when creating new games on demand. In this way, the generative AI used by the host system 105 “gets to know” the player and thus, automatically increases accuracy of the player's game creation desires. Initially, the AI can take it as a “feedback loop” when the player keeps asking the AI to revise X content provided by the AI.

According to one embodiment, the host system 105 can find other like-minded players and include their preferences and trends into the actual player's demanded game. Once created initially, the host system 105 could provide a preview of the game or teaser its most significant game elements, e.g., in a short video, description, highlighting, tutorial, etc. The host system 105 could then ask the player if they are fine with that or if they would like to change anything further and/or adjust the game at any point in time, on-the-fly. For example, while playing, the player can express any further demands on the game and the host system 105 can adjust the game accordingly in real-time. While playing, the player can express demands for further game elements and/or components which were not mentioned in the initial creation. For example, the player could ask the host system 105 “Give me a game that like-minded people love but replace it with Avatar characters.” In another example, the player can ask the host system 105 what elements can be changed, or which changes cannot be applied.

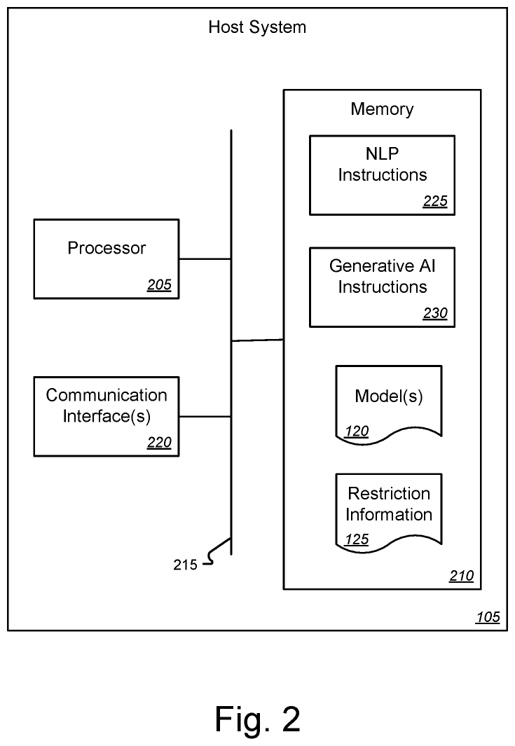

FIG. 2 is a block diagram illustrating additional details of components of an exemplary host system for configuring an electronic game of chance according to one embodiment of the present disclosure. As illustrated in this example, the host system 105 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the host system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communications interfaces 320. The communication interfaces 220 can comprise, for example, Ethernet, Bluetooth, WiFi, or other type of wired or wireless communications interfaces. The memory 210 can store therein a set of NLP instructions 225 which, when executed by the processor 205, causes the processor 205 to receive, from a gaming system 115 or mobile device 125, through the communications interface(s) 220, an audio stream comprising a natural language description of an electronic game of chance from a player 120 of the game. The NLP instructions 225 can further cause the processor 205 to perform natural language processing on the received audio stream and extract a set of parameters for the electronic game of chance from the received audio stream based on the natural language processing of the received audio stream.

The memory 210 can also have stored therein a set of generative AI instructions 230 which, when executed by the processor 205, can cause the processor 205 to generate a set of configuration information defining the electronic game of chance based on the extracted set of parameters for the electronic game of chance and one or more game models 130. The generated set of configuration information can relate to and/or define one or more of game play characteristics of the electronic game of chance, a theme for the electronic game of chance, audio characteristics of the electronic game of chance, mathematic characteristics of the electronic game of chance, and/or other features, functions, or aspects of the game. In some cases, the extracted set of parameters for the electronic game of chance and the set of configuration information defining the electronic game of chance can further define a sub-game conducted within the electronic game of chance.

In some cases, generating the set of configuration information defining the electronic game of chance can be further based on a set of restrictions placed on the electronic game of chance. For example, the set of restrictions can comprise a set of regulatory restrictions. In such cases, the generative AI instructions 230 can further cause the processor 205 to determine a geographic location of the gaming system 115 and the set of regulatory restrictions can be selected from a set of restriction information 135 based on the determined geographic location of the gaming system 115. Additionally, or alternatively, restriction information 135 can be selected that comprises one or more of restrictions based on a game type for the electronic game of chance indicated by the extracted set of parameters for the electronic game of chance, restrictions on a random number generator used by the electronic game of chance, restrictions defined by an operator of the gaming system, restrictions defined by a manufacturer of the gaming system, and/or others.

In some cases, the generative AI instructions 230 can further cause the processor 205 to make a determination as to whether the set of parameters and/or configuration information is complete enough for the gaming system 115 to implement the electronic game of chance. In response to determining the set of parameters and/or configuration information is not complete enough for the gaming system 115 to implement the electronic game of chance, the generative AI instructions 230 can further cause the processor 205 to send a message to the gaming system 115 or mobile device 125 of the player 120 through the communications interface(s) 220. The message can comprise a request for additional description of the electronic game of chance. In response, the generative AI instructions 230 and NLP instructions 225 can further cause the processor 205 to receive and process a further audio stream, extract additional parameters, and generate further configuration information. Additionally, or alternatively, the generative AI instructions 230 can further cause the processor 205 to send a message to the gaming system 115 or mobile device 125 of the player 120 requesting confirmation or acceptance of the generated configuration information.

In response to determining the generated configuration information has been confirmed or accepted, the generative AI instructions 230 can further cause the processor 205 to provide the generated set of configuration information defining the electronic game of chance to the gaming system 115 through the communications interface(s) 220. In some cases, the generative AI instructions 230 can further cause the processor 205 to send to the gaming system 115 an electronic message comprising an explanation to a player of the electronic game of chance.

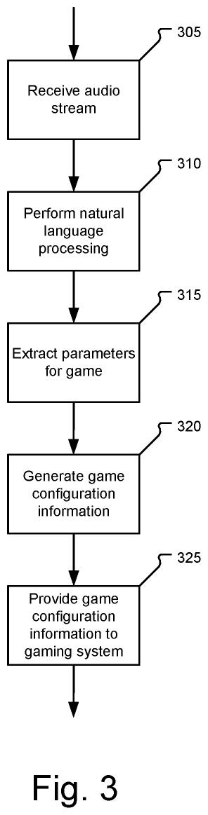

FIG. 3 is a flowchart illustrating an exemplary process for performing electronic game of chance configuration according to one embodiment of the present disclosure. As noted above, configuring the electronic game of chance can performed in real-time upon initiation of the electronic game of chance and/or after conducting the electronic game of chance for a period of time to update or modify the electronic game of chance. As illustrated in this example, configuring an electronic game of chance can comprise receiving 305, from a gaming system 115 or mobile device 125, an audio stream comprising a natural language description of an electronic game of chance from a player 120 of the game. Natural language processing can be performed 310 on the received audio stream.

A set of parameters for the electronic game of chance can be extracted 315 from the received audio stream based on the natural language processing of the received audio stream and a set of configuration information defining the electronic game of chance can be generated 320 based on the extracted set of parameters for the electronic game of chance. The generated set of configuration information can relate to and/or define one or more of game play characteristics of the electronic game of chance, a theme for the electronic game of chance, audio characteristics of the electronic game of chance, mathematic characteristics of the electronic game of chance, and/or other features, functions, or aspects of the game. In some cases, the extracted set of parameters for the electronic game of chance and the set of configuration information defining the electronic game of chance can further define a sub-game conducted within the electronic game of chance. The generated set of configuration information defining the electronic game of chance can then be provided 325 to the gaming system 115.

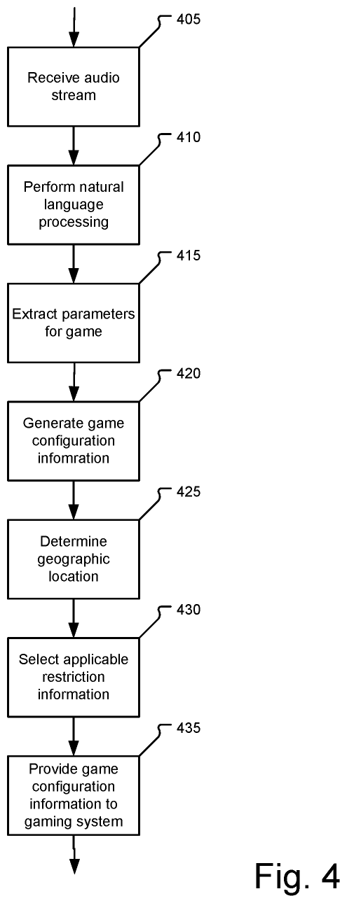

FIG. 4 is a flowchart illustrating an exemplary process for performing electronic game of chance configuration according to another embodiment of the present disclosure. As illustrated in this example, configuring an electronic game of chance can comprise receiving 405, from a gaming system 115 or mobile device 125, an audio stream comprising a natural language description of an electronic game of chance from a player 120 of the game. Natural language processing can be performed 410 on the received audio stream. A set of parameters for the electronic game of chance can be extracted 415 from the received audio stream based on the natural language processing of the received audio stream and a set of configuration information defining the electronic game of chance can be generated 420 based on the extracted set of parameters for the electronic game of chance.

In some cases, generating 420 the set of configuration information defining the electronic game of chance can be further based on a set of restrictions placed on the electronic game of chance. For example, the set of restrictions can comprise a set of regulatory restrictions. In such cases, a geographic location of the gaming system 115 can be determined 425 and the set of regulatory restrictions can be selected 430 from a set of restriction information based on the determined geographic location of the gaming system. Additionally, or alternatively, restriction information can be selected 430 that comprises one or more of restrictions based on a game type for the electronic game of chance indicated by the extracted set of parameters for the electronic game of chance, restrictions on a random number generator used by the electronic game of chance, restrictions defined by an operator of the gaming system, restrictions defined by a manufacturer of the gaming system, and/or others. The generated set of configuration information defining the electronic game of chance can then be provided 435 to the gaming system 115.

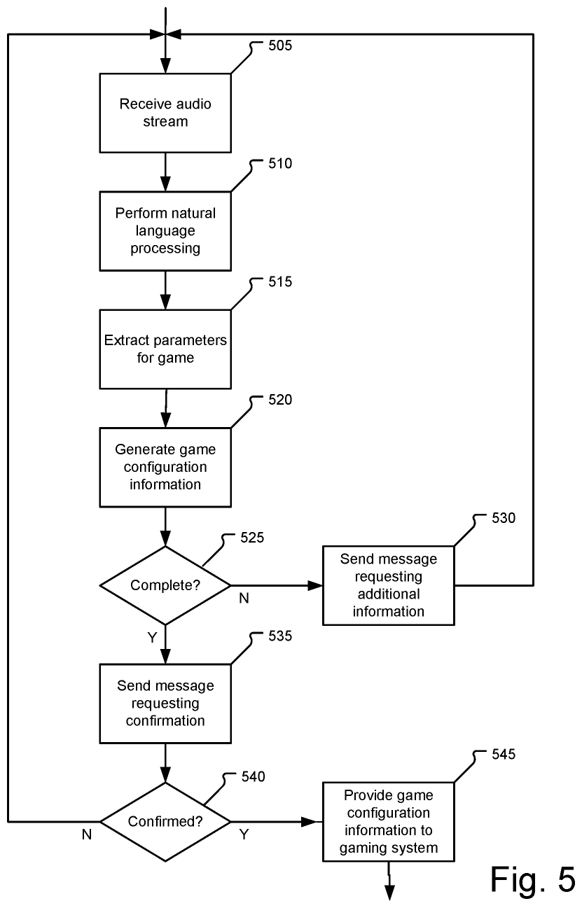

FIG. 5 is a flowchart illustrating an exemplary process for performing electronic game of chance configuration according to yet another embodiment of the present disclosure. As illustrated in this example, configuring an electronic game of chance can comprise receiving 505, from a gaming system 115 or mobile device 125, an audio stream comprising a natural language description of an electronic game of chance from a player 120 of the game. Natural language processing can be performed 510 on the received audio stream. A set of parameters for the electronic game of chance can be extracted 515 from the received audio stream based on the natural language processing of the received audio stream and a set of configuration information defining the electronic game of chance can be generated 520 based on the extracted set of parameters for the electronic game of chance.

In some cases, a determination 525 can be made as to whether the set of parameters and/or configuration information is complete enough for the gaming system 115 to implement the electronic game of chance. In response to determining 525 the set of parameters and/or configuration information is not complete enough for the gaming system 115 to implement the electronic game of chance, a message can be sent 530 to the gaming system 115 or mobile device 125 of the player 120. The message can comprise a request for additional description of the electronic game of chance. In response, a further audio stream may be received 505 and processed 510, additional parameters may be extracted 515 and further configuration information may be generated 520. Additionally, or alternatively, a message can be sent 535 to the gaming system 115 or mobile device 125 of the player 120 requesting confirmation of acceptance of the generated 520 configuration information. In response to determining 540 the generated 520 configuration information has been confirmed or accepted, the generated 545 set of configuration information defining the electronic game of chance can then be provided 435 to the gaming system 115.

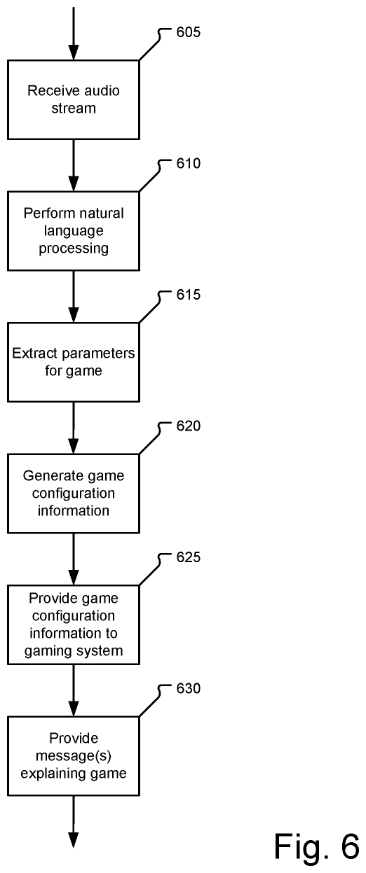

FIG. 6 is a flowchart illustrating an exemplary process for performing electronic game of chance configuration according to still another embodiment of the present disclosure. As illustrated in this example, configuring an electronic game of chance can comprise receiving 605, from a gaming system 115 or mobile device 125, an audio stream comprising a natural language description of an electronic game of chance from a player 120 of the game. Natural language processing can be performed 610 on the received audio stream. A set of parameters for the electronic game of chance can be extracted 615 from the received audio stream based on the natural language processing of the received audio stream and a set of configuration information defining the electronic game of chance can be generated 620 based on the extracted set of parameters for the electronic game of chance. The generated set of configuration information defining the electronic game of chance can then be provided 625 to the gaming system 115. In some cases, an electronic message comprising an explanation to a player of the electronic game of chance can also be sent 630 to the gaming system.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A system comprising:
a processor; and
a memory coupled with and readable by the memory and storing therein a set of instruction which, when executed by the processor, causes the processor to:
receive, from a gaming system, an audio stream comprising a natural language description of an electronic game of chance;
perform natural language processing on the received audio stream;
extract, from the received audio stream, a set of parameters for the electronic game of chance based on the natural language processing of the received audio stream;
generate a set of configuration information defining the electronic game of chance based on the extracted set of parameters for the electronic game of chance; and
provide, to the gaming system, the generated set of configuration information defining the electronic game of chance.

2. The system of claim 1, wherein generating the set of configuration information defining the electronic game of chance is further based on a set of restrictions placed on the electronic game of chance.

3. The system of claim 2, wherein the set of restrictions comprise a set of regulatory restrictions.

4. The system of claim 3, wherein the instructions further cause the processor to determine a geographic location of the gaming system and wherein the set of regulatory restrictions are selected based on the determined geographic location of the gaming system.

5. The system of claim 2, wherein the set of restrictions comprise restrictions based on a game type for the electronic game of chance indicated by the extracted set of parameters for the electronic game of chance.

6. The system of claim 5, wherein the restrictions based on the game type for the electronic game of chance comprise restrictions on a random number generator used by the electronic game of chance.

7. The system of claim 2, wherein the set of restrictions comprise restrictions defined by an operator of the gaming system.

8. The system of claim 2, wherein the set of restrictions comprise restrictions defined by a manufacturer of the gaming system.

9. A method for configuring an electronic game of chance, the method comprising:
receiving, by a host system, from a gaming system, an audio stream comprising a natural language description of an electronic game of chance;
performing, by the host system, natural language processing on the received audio stream;
extracting, by the host system, a set of parameters for the electronic game of chance from the received audio stream based on the natural language processing of the received audio stream;
generating, by the host system, a set of configuration information defining the electronic game of chance based on the extracted set of parameters for the electronic game of chance; and
providing, by the host system, to the gaming system, the generated set of configuration information defining the electronic game of chance.

10. The method of claim 9, wherein configuring the electronic game of chance is performed in real-time upon initiation of the electronic game of chance.

11. The method of claim 9, wherein configuring the electronic game of chance comprises changing the electronic game of chance after conducting the electronic game of chance for a period of time.

12. The method of claim 9, wherein the extracted set of parameters for the electronic game of chance and the set of configuration information defining the electronic game of chance further define a sub-game conducted within the electronic game of chance.

13. The method of claim 9, further comprising sending, from the host system, to the gaming system, an electronic message comprising a request for confirmation of the extracted set of parameters for the electronic game of chance.

14. The method of claim 9, further comprising sending, from the host system, to the gaming system, an electronic message comprising a request for additional description of the electronic game of chance.

15. The method of claim 9, further comprising sending, from the host system, to the gaming system, an electronic message comprising an explanation to a player of the electronic game of chance.

16. A non-transitory, computer-readable medium comprising a set of instructions stored therein which, when executed by a processor, causes the processor to:
receive, from a gaming system, an audio stream comprising a natural language description of an electronic game of chance;
perform natural language processing on the received audio stream;
extract, from the received audio stream, a set of parameters for the electronic game of chance based on the natural language processing of the received audio stream;
generate a set of configuration information defining the electronic game of chance based on the extracted set of parameters for the electronic game of chance; and
provide, to the gaming system, the generated set of configuration information defining the electronic game of chance.

17. The non-transitory, computer-readable medium of claim 16, wherein the instructions further cause the processor to train a natural language model on a voice of a player providing the audio stream comprising the natural language description of the electronic game of chance.

18. The non-transitory, computer-readable medium of claim 16, wherein the instructions further cause the processor to save the generated set of configuration information defining the electronic game of chance in an electronic record associated with a player providing the audio stream comprising the natural language description of the electronic game of chance.

19. The non-transitory, computer-readable medium of claim 16, wherein the instructions further cause the processor to provide the generated set of configuration information defining the electronic game of chance to a plurality of players in an online community.

20. The non-transitory, computer-readable medium of claim 16, wherein the instructions further cause the processor to learn preferences for a player providing the audio stream comprising the natural language description of the electronic game of chance.
